(19) United States
(12) Patent Application Publication
(10) Pub. No.: US 2002/0050566 A1
(43) Pub. Date: May 2, 2002

(54) Arrangement and a method for inspection

(76) Inventors: Torbjorn Nilsson, Kungsbacka (SE); Mikael Johansson, Molnlycke (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/001,290

(22) Filed: Nov. 1, 2001

(30) Foreign Application Priority Data
Nov. 1, 2000 (SE) 0003985-9

(51) Int. Cl. G01N 21/71

(52) U.S. Cl. 250/341.6

(57) ABSTRACT

The present invention relates to an arrangement for non-destructive inspection of joint layer(s) in a multilayer structure (40) comprising at least a first layer (1) with a first outer surface, a second layer (2) with a second outer surface and a joint layer (3) for joining said first and second layers. It comprises a heating arrangement (10) for homogeneously heating up said second outer surface of the multilayer structure (40), a detecting arrangement (20) comprising a thermographic imaging system for registering the infrared radiation pattern representative of the temperature distribution on said first outer surface of the multilayer structure (40) and processing means (30) for, based on the temperature distribution, establishing at least the eventual presence of (a) cavity/cavities in the joint layer (3).

### TECHNICAL FIELD

The present invention relates to an arrangement for non-destructive inspection of joint layers in a multilayer structure which comprises at least a first and a second layer joined by a joint layer. The invention also relates to a method of performing inspection of a joint layer in a multilayer structure.

### STATE OF THE ART

When two layers, of the same or of different materials, are joined by a joining layer, or a bonding layer, voids and cavities are often produced. Such cavities or voids may cause a lot of problems for example when heat should be conducted from hot components, when Radio Frequency (RF) conductors are grounded, and they may also have a detrimental effect on mechanical strength and tensile properties. For microelectronic components within the field of microelectronic or particularly within microwave applications, the problems concerning heat conductivity and radio frequency consist in that heat and radio frequency signals have to travel longer distances in the joint material, if there are cavities, before a heat sink or ground respectively is reached. Another serious problem is that, after lamination by a joining material, there is no way to establish if there actually are any cavities and, if there are, then where they are located, without destroying the laminated structure. One method that frequently is used is based on destructive tests in which the joining layer is revealed. Through such testing it is possible to determine how different parameters of the joining process affect the quality of the joint, but such methods can of course not be used for fast, non-destructive inspection. By using ultrasonic microscopes it is possible to detect voids or cavities. Such equipment is however expensive, slow, and will in practice often destroy the electronic since it has to be merged into a liquid medium. Furthermore it can not be used for on-line operation.

Another known device comprises a micro-focus X-ray apparatus. This device is however also large and it is extremely difficult to obtain a contrasting effect between the air filled cavity and the bonding material, for example the polymer part of an adhesive film. A method based on such a device is not appropriate for use in an automatic system for detection of cavities or voids. The equipment is expensive and has to be kept under strict control, only used by skilled operators, and well protected.

Other known methods are based on using IR-(Infra Red) cameras for measurements on seals or joints. The joints are heated up and subsequently passively cooled down. The temperature is measured by use of IR cameras and the response of a pulsed procedure is compared to “good” reference seals or joints. It is possible to detect angular errors of components, bad placement in X-Y-direction and if there is too little or too much joint material. Such methods are however not relevant for bonding materials based on polymers such as for example thermosetting materials, e.g. adhesive films, thermoplastic materials etc. Furthermore such methods are only applicable to directly exposed seals or joints in the line-of-sight of an optical detection equipment. Such methods can be not be used for inspection of joints or bonding materials used to laminate two materials, or two layers wherein the joint layers are not accessible for direct, visual inspection.

DE-C1-19 841 968 shows to a method to be used for large objects. A laser is used for heating up, point by point. Small cavities can not be detected, and it would not function within electronics or microelectronics. It is also a slow method, and cavities will be detected one by one. The method is based on scanning, which is appropriate for large objects, e.g. airplane wings, but it does not work for small sized components.

### SUMMARY OF THE INVENTION

What is needed is therefore an arrangement for inspecting invisible or concealed joints for joining materials (or layers) which is non-destructive. Further such an arrangement is needed which is small and not bulky. An arrangement is also needed which is suitable for automatical operation for detecting cavities or voids in concealed joints joining two materials. Further an arrangement is needed which can be used for on-line operation or for sampling tests or for inspection of singular multilayer structures in which two layers are joined by a joint layer.

Further still an arrangement is needed which can be used for detection of voids or cavities in adhesive materials based on polymers such as thermoplastic materials and thermosetting materials. In addition thereto an arrangement is needed which is cost-effective and fast. Still further an arrangement is needed which can be used within the area of microelectronics or particularly within microwave electronics and to detect small cavities, particularly of millimeter size. The cavities are generally gas-filled (e.g. air) but they may also be vacuum cavities.

Therefore the present invention provides for an arrangement for non-destructive inspection of joint layers in a multilayer structure comprising a first layer, a second layer and a joint layer for joining said first and second layers. The arrangement comprises a heating arrangement for homogeneously heating up a second layer of the multilayer structure, or a second outer surface, also called the second outer surface of the multilayer structure, a detecting arrangement which comprises a thermographic imaging system for registering the infrared radiation pattern representative of the temperature distribution on the other (first) outer surface of the multilayer structure. Then all cavities can be seen at the same time. Processing means are also provided for, based on the temperature distribution pattern, establishing at least the presence of cavities in the concealed joint layer. In an advantageous implementation the thermographic imaging system comprises an IR-radiation detection arrangement. The infrared radiation emitted from the first outer surface is then detected. The IR-detection arrangement may with advantage be connected to a computer system including an image processing software and/or to a display screen.

If there is a cavity in the joint layer, it takes longer time for the heat transferred to the second outer surface by the heating means, to be transported from the second outer surface towards the first layer if there is a cavity inbetween since then the heat can be said to be conducted so as to make a deviation around the cavity and therefore it will take more time until the region above the cavity is heated up to the same temperature as surrounding areas or regions under which there are no cavities. Thus, the radiation emitted is measured or observed by an infrared camera during a thermal transition i.e. thermal transport during heating up and then it is possible to observe or detect at least the location of a cavity. During a thermal transition, heating up in this case, the surface temperature distribution depends on whether there are any cavities or not in the joint layer. Therefore, with a substantially evenly heated second outer surface, shown as different surface temperatures on the opposite, first, outer surface, infrared radiations of various powers, will correspond to the presence of cavities. Spots with a lower temperature indicate that there is a cavity in the underlying joint layer.

In a particular embodiment the heating arrangement comprises a heating plate or similar enabling a fast and even, homogeneous heating up of the second outer surface of a multilayer structure. It may be brought in close contact with the second outer surface, but in an alternative implementation heating up is achieved in a contactless manner such that the whole inspection procedure may be contactless. Many different kinds of heating means may of course be used, e.g. lamps, lasers etc. Heating up may be done in principle from any temperature as long as the properties of particularly the joint layer are not affected in an adverse manner. The multilayer structure may e.g. also be cooled down to a low temperature before heating up.

As referred to above the detecting arrangement is used to detect the infrared radiation pattern representative of the temperature distribution on the first outer surface. Particularly the detection is performed or initiated substantially simultaneously with the heating up of the second outer surface to register the transient process of heat transport across the multilayer structure, or in other words the thermal transition. In a particular implementation the detecting means are at least activated before the temperature distribution has been stabilized across the first outer surface.

The processing system may comprise a processing system for, based on the registered temperature distribution information, establishing cavities of at least a minimum predetermined size. In a particularly advantageous implementation the processing means comprises a processing system able to determine the size and/or the dimensions of cavities of at least a given minimum size. Alternatively all cavities possible to detect are indicated, i.e. there is a natural limit given by what the equipment actually is able to detect.

In an advantageous implementation the arrangement is used for automatic on-line operation such that a number of subsequent multilayer structures can be inspected, which structures are arranged, e.g. on a line, to move in relation to the arrangement.

In an alternative implementation the inspection arrangement is mobile and then it may be implemented for automatic on-line operation as well, with the difference that multilayer structures are fixed but the inspection arrangement is moved.

Alternatively or additionally the arrangement is manually operable. The arrangement may also be operated automatically in general, although not for on-line operation.

Particularly the arrangement is used to inspect multilayer structures in which the coefficients of thermal conductivity of the first layer and of the joint layer are lower than that of the second layer. Particularly the coefficient of thermal conductivity of the first layer is lower than 50 [W/mK]. In one particular implementation the coefficient of thermal conductivity of the first layer is about 3 [W/m.K]. The important thing is that the first layer shows a thermal conductivity and a thermal diffusivity which are not too high. The joint layer particularly comprises a polymer based material, such as a thermoplastic material or a thermosetting a material, an adhesive film or similar with a comparatively low coefficient of thermal conductivity. The second layer particularly comprises a metal, a metal alloy or a composite, or graphite, whereas the first layer may comprise a ceramic material, e.g. alumina, LTCC or a polymer, such as FR4 plates or a metal, metal alloy or metal a composite. (The second layer may show good heat conducting properties).

The heating arrangement particularly heats up the second layer from e.g. room temperature to a temperature of approximately 200° C. or below that, preferably to a temperature between 100-150° C. Also other temperatures are of course also possible, it should however be prevented that the joint layer melts or that heating in any way is detrimental to the joint layer material properties.

To meet one or more of the objects initially referred to, the invention also discloses a method for non-destructively inspecting joint layers in a multilayer structure comprising at least a first layer with a first outer surface forming one of the outer surfaces of the multilayer structure, and a second layer with a second outer surface forming the opposite outer surface of the multilayer structure and a joint layer for joining said first and second layers.

The method includes the steps of; providing the structure between a heating arrangement and a detecting arrangement; heating up the second layer/the second outer surface; establishing the temperature distribution on the first outer surface by means of a thermographic imaging system; analyzing the IR radiation pattern or the temperature distribution pattern for detecting cavities or voids in the joint layer.

In a particular implementation the step of establishing the temperature distribution comprises the steps of; recording the infrared radiation pattern emitted from said first surface by means of an equipment based on IR-radiation detection, e.g. an IR video, IR scanner or an IR-camera; converting the emitted infrared radiation pattern to a temperature distribution pattern. The method may also comprise the step of; manually providing a multilayer structure in a position enabling inspection between the heating arrangement and thermographic imaging system. Alternatively the method includes the steps of; automatically feeding a plurality of subsequent multilayer structures on a line into position for inspection; operating an IR-detection arrangement forming a thermographic imaging system on-line. In an advantageous implementation the method includes the steps of; applying heat to the second layer in a manner allowing a fast and even heating up; activating the detecting arrangement substantially simultaneously with heating up to allow recording of the transient procedure of heat migration on the first outer surface. The detecting arrangement may also be activated substantially as soon as a multilayer structure is disposed on, or close to a heating arrangement or when the heating arrangement is activated in case it is not already in a heating phase.

The method may particularly comprise the step of heating up the second layer from e.g. room temperature to a temperature of approximately 200° C. or below that, preferably to a temperature between 100-150° C. (The starting temperature does of course not have to be room temperature; it may well be a lower or a higher temperature; in principle any temperature will do while still considering that the materials are not negatively affected neither by the starting temperature, nor by the temperature to which heating up is performed.)

In an advantageous implementation the method includes the step of; evaluating the temperature distribution pattern using a processing system to determine the size of cavities, e.g. cavities exceeding a given value. The method may comprise the steps of; providing reference values on temperature differences or temperature distribution patterns corresponding to cavities of a given size; comparing obtained temperature distribution patterns or temperature values with said reference values to determine the sizes of cavities.

Particularly the method may include the steps of; defining a maximum limit for the size of acceptable cavities; comparing the sizes of a detected cavity with said maximum value; automatically activating an alarm if a joint layer contains a cavity/cavities exceeding said maximum value. In a particular implementation the activation of the alarm leads to the step of; for on-line operation; automatically indicating a multilayer structure having a joint layer with one or more cavities exceeding the maximum value. Particularly the method is implemented for multilayer structures in which the second layer comprises a metal, metal alloy or composite, graphite or similar, whereas the first layer comprises a ceramic material, or a polymer or a metal, metal alloy, or a (metal) composite. The joint layer may comprise a polymer, e.g. a thermoplastic material or a thermosetting material. The second layer should have a coefficient of thermal conductivity which is comparatively high whereas the first layer should have a coefficient of thermal conductivity which is comparatively low such that heat is not too quickly transported throughout the first layer, in other words that the temperature is not evened out too quickly on the first outer surface. (Although there will still be a faint pattern left after a long time). The faster the heat is distributed to/on the first outer surface, the faster IR-detection equipment is required.

It is an advantage of the invention that it gets possible to, in a fast, reliable and efficient manner detect cavities in concealed joint layers, particularly for the above mentioned or similar materials, and that it can be implemented for on-line operation or automatically such that multilayer structures can be inspected without being destroyed and in some cases even contactlessly.

### BRIEF DESCRIPTION OF THE DRAWINGS

The invention will in the following be further described in a non-limiting manner and with reference to the accompanying drawings in which:

FIG. 1 shows an arrangement according to the invention,

FIG. 2 shows an arrangement according to the invention for online operation,

FIG. 3 schematically illustrates the transportation of heat from a second, heated up, layer to the outer surface of a first layer when there is a cavity in the joint layer,

FIG. 4 schematically illustrates the temperature distribution on the outer surface of a first layer, and

FIG. 5 is a flow diagram describing the procedure of detecting cavities in a joint layer of a multilayer structure.

### DETAILED DESCRIPTION OF THE INVENTION

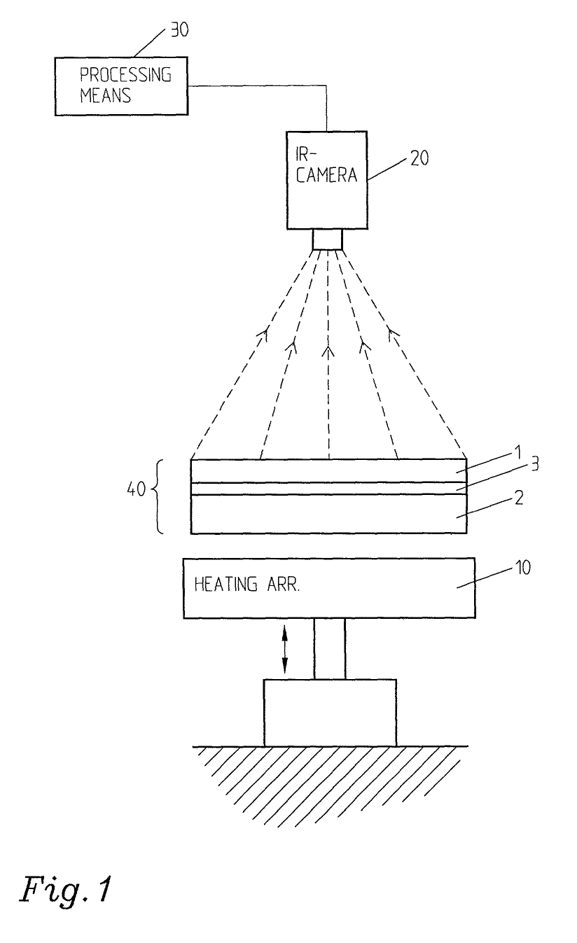

In advantageous implementations of the inventive concept, an arrangement and a method, as will be further described below, can be used to detect voids and cavities in joint layers, particularly within microelectronics. Even more particularly an arrangement according to the invention is used to determine the size of said voids or cavities. Generally a multilayer structure, or a plate, consists of two plates of a solid material 1, 2 which are laminated through the use of the thin joint layer 3, cf. FIG. 1. Undesired cavities produced during lamination are detected in that the multilayer structure quickly is heated up, in a particular implementation from below, for example by a heating plate or more generally a heating arrangement. A first outer surface, in the implementation of FIG. 1 the top surface, will then show a temperature distribution which indirectly is measured at the same time as the second outer surface, here the bottom outer surface of the second layer, is heated up, by the use of IR-detection equipment 20 that detects the emitted IR radiation. During the transient procedure when heat is transported or spread on the first outer surface or the upper surface, the cavities can be observed on the upper outer surface (in this case). The pattern through which the cavities, if present, can be detected, will also remain after temperature “equilibrium” has been reached, although, then the pattern is fainter.

A precondition is that the coefficient of heat conductivity of the first layer 1, i.e. in this case the top layer, from which the IR radiation is detected, is not too high because then the heat would be transported too quickly to be detected; at least for comparatively simple, conventional IR-cameras would it spread too quickly. Also for the joint layer the coefficient of heat conductivity should not be too high for the same reasons. The heat conductivity of the second layer 2, which is heated up by the heating arrangement 10, is however actually not critical, and it may be high.

Examples of materials for which the inventive concept can be implemented are thick film ceramic with a coefficient of heat conductivity, λ below 50 W/mK, LTCC (Low Temperature Cofired Ceramic), and a thermoplastic material with λ=2-3 W/mK. The inventive arrangement/method can of course also be implemented for any other materials and the indication of these materials should of course not be interpreted as limitative.

The IR-detection equipment 20 is generally connected to processing means 30. Generally an optical software system can be used in which differences in color, greyness or reflection from an object are registered and compared to a reference model. However, this can be done in many ways. The main point is that in one way or another temperature differences are correlated with actual cavities, particularly sizes of cavities. In an advantageous implementation an alarm is activated if some limiting value, e.g. different colors or different greyness in the detected IR pattern, a given temperature gradient, a given temperature difference etc., is exceeded. An indication may be provided that the inspected multilayer structure contains unacceptable cavities. This can be provided for in different manners.

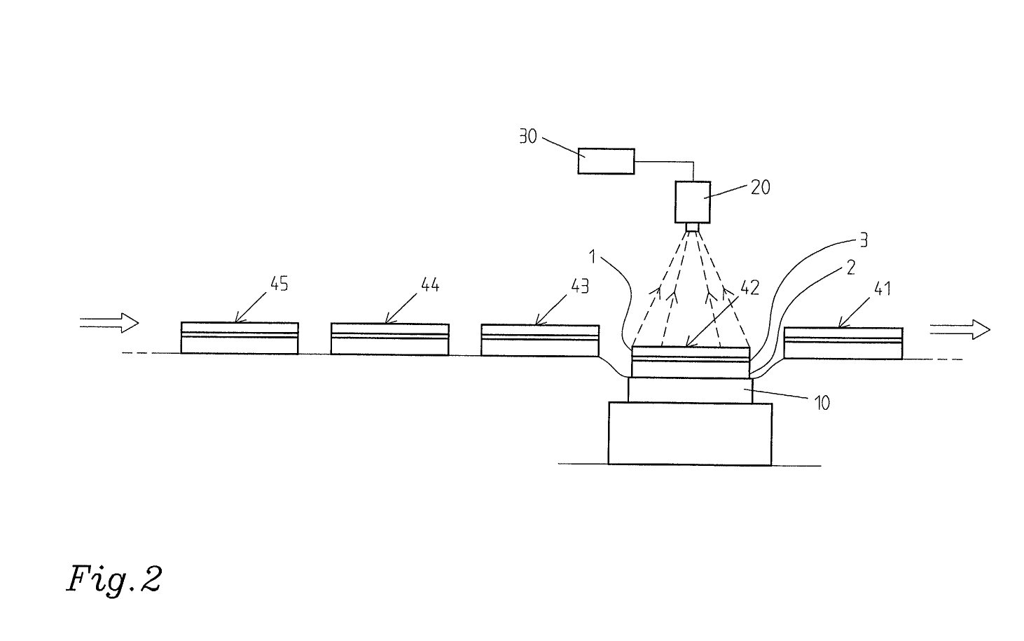

FIG. 2 shows an arrangement similar to that of FIG. 1 which here is used for on-line operation. A plurality of subsequent multilayer structures 41, 42, 43, 44, 45 are inspected through the use of the detecting arrangement. When a multilayer structure, according to the figure multilayer structure 42, is in position enabling inspection, the second layer, here the bottom layer is heated up by heating arrangement 10 which is mounted on a carrier element. Substantially simultaneously IR-detection equipment, e.g. an IR-camera 20 is activated to make a number of pictures with a given frequency. The results of the IR-radition measurements are processed by a processing means 30, and if it is detected that multilayer structure 42 contains one (or more) cavities exceeding a given size, or simply detectable cavities, it is indicated that mulitlayer structure 42 should be discarded or repaired or whatever the relevant action may be. It is also possible to avoid setting of a limit relating to the size of a cavity, by simply using the natural limit as resulting from a practical point of view, i.e. when a cavity is detectable, a multilayer structure is not acceptable, or needs to be indicated as containing cavities.

The invention will now be further described with reference to one embodiment in which inspection is performed of a multilayer structure 40 comprising a first layer or a substrate of a ceramic material and a second layer 2 comprising a thin carrier which are laminated by the use of an adhesive joint layer or bonding layer 3 which for example may comprise an adhesive film. When the joint layer 3 is heated up during the bonding operation, there is a risk that cavities are produced and such cavities will remain in the joint after lamination and cooling down of the multilayer structure, e.g. a multichip module (MCM).

As referred to earlier the consequences may be that grounding under RF-conductors will be of inferior quality, or that the heat conduction is poor at critical spots etc.

In an advantageous implementation the joint layer is inspected when the joint layer has been provided on the second layer 2, e.g. the thin carrier, and the first layer 1, e.g. the substrate, has been provided on top thereof through application of heat and pressure. The carrier or the second layer may be in direct contact with a thin adhesive film. Above the adhesive film a first layer comprising a ceramic plate which is thicker than the adhesive layer is provided. The carrier layer may for example have a coefficient of heat conductivity (λ) of 180 [W/mK] at 300 K and the first layer may be a ceramic with a coefficient of heat conductivity of less than 50 at 300 K. The adhesive film may have a coefficient of heat conductivity of about 5 [W/mK] at 300 K. It should be clear that these parameters are merely given for exemplifying reasons and indicate one multicarrier structure among many different kinds of structures which with advantage can be inspected by the use of the inventive arrangement.

According to the invention cavities are detected by the use of thermodynamical principles. As a starting point a heat wave is created by fast heating up under the second layer 2 which, according to one embodiment is provided on a heating plate at a temperature of 150° C. The first outer surface, e.g. the top layer or said first layer 1, also denoted the substrate, will be heated up within seconds, homogeneously with the exception of the part(s) that is/are located above a cavity in the joint layer 3. The temperature on this spot will be delayed and it will generally not even quite reach the temperature of the surroundings. The first outer surface, i.e. the top of the substrate, is examined by an IR-camera and a number of pictures are taken during a given time interval and a pattern results above a cavity. The temperature difference ΔT will depend on the coefficient of heat conductivity in the first layer at the relevant temperature, the thickness of the second layer, the dimensions of the cavity in the horizontal directions, i.e. parallell to the outer surfaces, and the thermal diffusivity of the first layer. ΔT is the temperature at a point in the first layer above the joint layer where it is homogeneous i.e. where there are no cavities, minus the temperature at a point in the first layer above the cavity, i.e. Tₛ-T_{cav}).

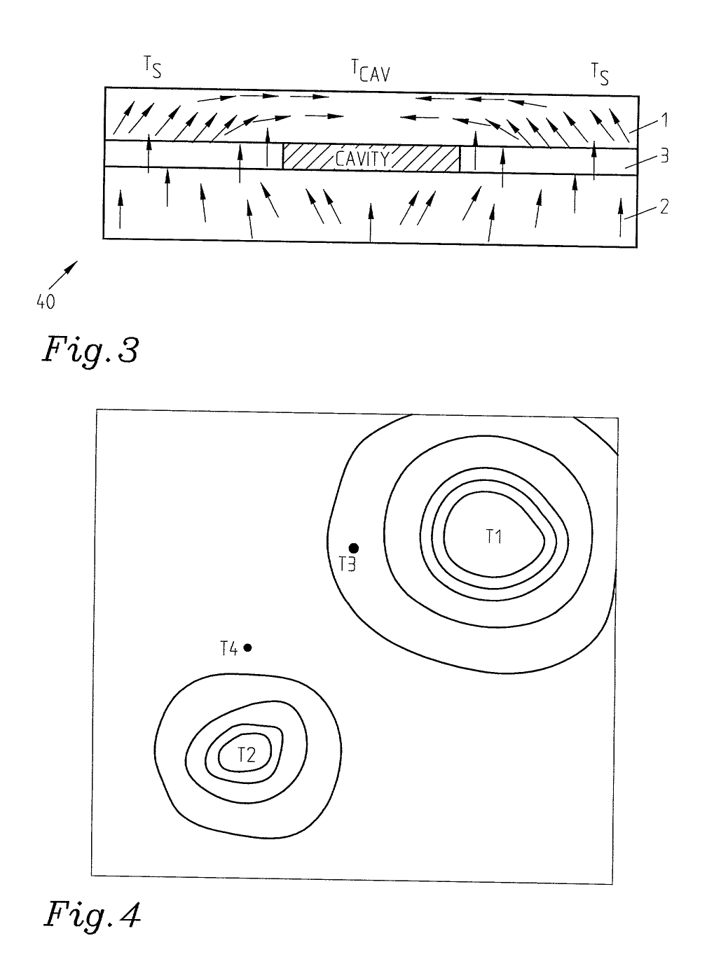

In FIG. 3 the principle of the heat flow to the first outer surface is very schematically illustrated. It should be noted that the thickness of the cavity is irrelevant in practice as well as in theory. If the wetting is bad, and a slot is produced which is about some micrometers thick, heat conduction is prevented. The illustrated cavity is distinct and it has a distinct outer border and it is singular. In reality it is generally less distinct and a plurality of other cavities may exist in the neighborhood. The figure will still explain that the procedure quite well. In the figure the arrows indicate the transport of heat and T_{CAV} indicates the temperature on the substrate above the cavity, whereas Tₛ illustrates the surrounding temperature on the substrate, i.e. the temperature on the first outer surface when there are not cavities in the joint layer. Thus the arrows illustrate the transport of heat when the carrier (second layer) 2 has been brought in close contact with e.g. a heating plate (or heated up in any other appropriate manner). In one advantageous implementation the heating arrangement comprises a plate with holes in it and a vacuum pump such that the multilayer structure is forced against the plate due to the produced vacuum to prevent an uneven distribution on the upper surface due to something else than cavities.

FIG. 4 schematically illustrates an example of a temperature distribution obtained with the method according to the present invention to illustrate the differences in temperature when at there are cavities in the joint layer. It is here supposed that a multilayer structure, e.g. of the dimensions and materials as discussed above is provided with two cut-outs in the joint layer. One cut-out comprises a circle with radius 5.5 mm and the other cut-out comprises a square with side 1.7 mm. The structure is temporarily attached (e.g. by the suction action of a vacuum pump) to heating plate and it is heated to a temperature of 150° C.

T1 corresponds to the temperature on the upper surface of the first layer above the circular cut-out and T2 corresponds to the detected temperature above the square shaped cut-out.

T3 and T4 correspond to temperatures measured on the upper surface in regions with no cavities. It can be seen that a larger cavity (the circle) produces a larger area with a lower temperature than a smaller cavity (corresponding to the square shaped cut-out). Moreover, the difference ΔT_{c}=T3-T1 is approximately 3,4° C. whereas ΔT_{sq}=T4-T2 approximately is 2,6° C. This is merely shown to illustrate an example on what can be detected and that a larger cavity gives a larger area with reduced temperature and it is based on experimental results showing that also small cavities can be detected.

In principle any appropriate IR-detection equipment can be used. It is used to detect the radiation of heat from a surface. All normal surfaces of a composite material will show a maximum intensity in the middle of the IR-domain. This IR-radiation is possible to detect by the equipment, e.g. a camera, and by use of appropriate software, a temperature map can be formed with a given resolution. Generally temperature difference of 0.2° C. can be detected. Long-wavelength IR-cameras measure IR-radiation between 8-12 μm which the best resolution around 40 μm. A short-wavelength camera detects wavelengths of 2-5.4 μm. Both kinds of cameras can be used. In order to avoid IR-radiation in a camera, from the lens and all other surfaces, the camera is advantageously kept at a low temperature and infrared radiation contributions from the camera itself are, to the largest extent possible, subtracted before an image is presented representative of the temperature distribution of the object, i.e. the first outer surface. Mostly this is done automatically in the camera. As referred to earlier, it does not have to be IR-cameras, but scanners, videos etc.

It should be clear that above merely some examples on materials were given. Generally the second layer comprises a metal, metal alloy or a metal composite, i.e. a thermal expansion controlled materials may be used. It may also comprise diamond, graphite etc. The first layer may comprise a ceramic material such as alumina, Al₂O₃, LTCC (Low Temperature Cofired Ceramic) or a polymer, such as FR4 plates or a metal alloy such as Kovar. The joint layer particularly comprises a polymer-based material such as a thermoplastic material, a thermosetting material, an adhesive film or similar. Generally the first layer and the joint layer should have a coefficient of heat conductivity which is not too high whereas the second layer well might have a higher coefficient of heat conductivity. Generally D, wherein D is the thickness of the first layer, and/or the thermal diffusivity α=λ/cₚ×ρ, wherein λ is the coefficient of heat conductivity, ρ is the density and cₚ is the heat capacitivy, should be as low as possible which means that for a greater thickness D, a lower α is required and vice versa. Otherwise the resulting temperature distribution pattern will be less pronounced which imposes higher requirements on the IR-detection equipment, i.e. for a thicker material or for a higher thermal diffusivity, unless this is balanced by a lower value on α and D respectively, a faster IR-detection equipment will be needed. Particularly cavities having a size e.g. down to 1-2 mm can be detected.

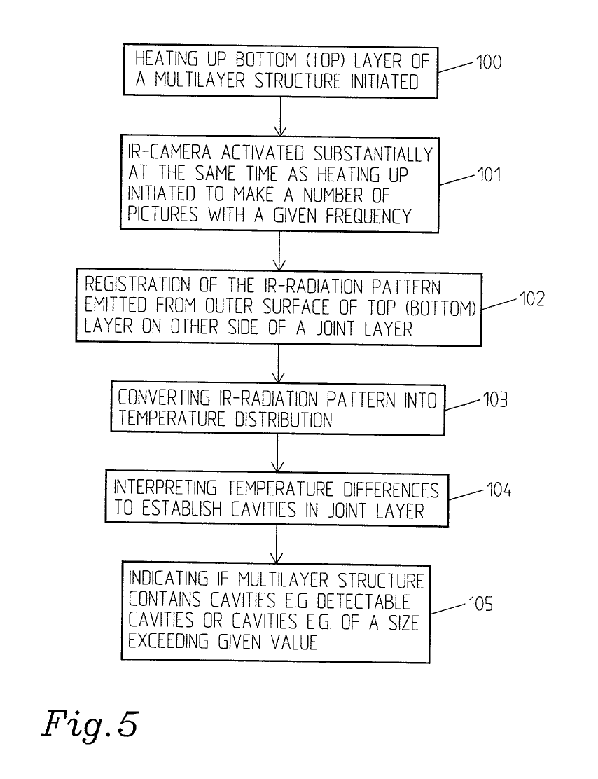

FIG. 5 is a schematical flow diagram describing a procedure of first heating up the bottom layer of a multilayer structure, 100. In an alternative embodiment heating up is provided on the top layer in which case the top layer is the second layer. Then of course the IR-detection equipment is mounted to detect the IR-radiation pattern on the bottom layer instead. The IR-detection arrangement is activated substantially simultaneously or at the same time as heating up is initiated to e.g. make a number of pictures during a given time interval, 101. The IR-radiation pattern emitted from the outer surface of the top (bottom) layer on the other side of a joint layer is registered, 102, and the IR-radiation pattern is converted into a temperature distribution pattern, 103, in any appropriate manner. The temperature differences are then interpreted to establish cavities in the joint layer, 104. Alternatively the IR-radiation pattern is interpreted since it is by experience known which IR-radiation pattern would correspond to a given temperature distribution pattern which information then is provided by the software of a processing means. Then is somehow indicated if an inspected multilayer structure contains cavities, it may be cavities of a given size or larger than that or it may simply be cavities which are detectable since there is a natural limit determining which size of cavities that can be detected (for a given equipment and for given properties of the multilayer structure), 105.

It should be clear that the concept also applies to multilayer structures containing more than one joint layer used to laminate a second layer and a first layer and a first layer and another first layer, e.g. when then is provided more than one ceramic layer or first layer which also are joined by joint layers. It should also be clear that the invention is not limited to the specifically illustrated embodiments, but that it can be varied in a number of ways without departing from the scope of the appended claims.

1. An arrangement for non-destructive inspection of joint layer(s) in a multilayer structure (40;41-45) comprising at least a first layer (1) with a first outer surface, a second layer (2) with a second outer surface and a joint layer (3) for joining said first and second layers, characterized in that it comprises a heating arrangement (10) for homogeneously heating up said second outer surface of the multilayer structure (40;41-45), a detecting arrangement (20) comprising a thermographic imaging system for registering the infrared radiation pattern representative of the temperature distribution on said first outer surface of the multilayer structure (40;41-45) and processing means (30) for, based on the temperature distribution, establishing at least the eventual presence of (a) cavity/cavities in the joint layer (3).

2. An arrangement according to claim 1, characterized in that the thermographic imaging system comprises an IR-radiation detection equipment (20).

3. An arrangement according to claim 1 or 2, characterized in that the heating means (10) comprises a heating plate, or laser, a lamp or similar enabling a fast heating up of the second outer surface of a multilayer structure (40;41-45).

4. An arrangement according to claim 1,2 or 3, characterized in that the detecting arrangement (20) is used to detect the infrared radiation pattern representative of the temperature distribution on the first outer surface substantially simultaneously with the heating up of the second outer surface to register the transient process of heat transport across the multilayer structure.

5. An arrangement according to any one of claim 1-3, characterized in that the detecting arrangement (20) is activated before a substantially homogeneous temperature distribution has been reached on the first outer surface.

6. An arrangement according to claim 4 or 5, characterized in that the processing means (30) comprises a processing system for, based on the registered temperature distribution information, detecting cavities of at least a given minimum size.

7. An arrangement according to claim 4,5 or 6, characterized in that the processing means (30) comprises a processing system able to determine the size and/or dimensions of cavities of at least a given minimum size.

8. An arrangement according to any one of the preceding claims, characterized in that it is used for automatic on-line operation such that a number of subsequent multilayer structures (41-45) can be inspected, which structures are arranged to move in relation to the arrangement.

9. An arrangement according to any one of claims 1-7, characterized in that it is mobile.

10. An arrangement according to any one of the preceding claims, characterized in that it at least is manually operable.

11. An arrangement according to any one of the preceding claims, characterized in that it is automatically operating.

12. An arrangement according to any one of the preceding claims, characterized in that it is used to inspect multilayer structures in which the thermal conductivity coefficients of the first layer (1) and of the joint layer are lower than that of the second layer (2).

13. An arrangement according to claim 12, characterized in that the coefficient of thermal conductivity of the first layer(s) (1) is/are lower than approximately 50 [W/mK].

14. An arrangement according to claim 12 or 13, characterized in that the joint layer (3) comprises a polymer based material, e.g. a thermoplastic material, a thermosetting layer, an adhesive film or similar.

15. An arrangement according to any one of the preceding claims used for inspecting joints (3) in multilayer structures (40;41-45) in which the second layer (2) comprises a metal, a metal alloy, composite, or graphite, the first layer (1) comprises a ceramic material, e.g. alumina, LTCC or a polymer, such as FR4 plates, or a metal alloy.

16. An arrangement according to any one of the preceding claims, characterized in that the heating arrangement (10) heats up the second layer (2) from e.g. about room temperature to a temperature of approximately 200° C. or below that, preferably to a temperature between 100-150° C., or from another temperature with an amount appropriate for detecting cavities.

17. A method for non-destructively inspecting joint layers in a multilayer structure comprising at least a first layer with a first outer surface forming one of the outer surfaces of the multilayer structure, and a second layer with a second outer surface forming the opposite outer surface of the multilayer structure and a joint layer for joining said first and second layers, characterized in that it comprises the steps of:
providing the structure between a heating arrangement and a detecting arrangement;
heating up the second layer/second outer surface homogeneously;
establishing the temperature distribution on the first outer surface by means of a thermographic imaging system;
analyzing the temperature distribution pattern for detecting cavities or voids in the joint layer.

18. A method according to clam 17, characterized in that the step of establishing the temperature distribution comprises the steps of:
recording the infrared radiation pattern emitted from said first surface, by means of an IR-radiation detection equipment;
converting the emitted infrared radiation pattern to a temperature distribution pattern.

19. A method according to claim 18, characterized in that it comprises the step of:
manually providing the multilayer structure in a position enabling inspection between the heating arrangement and the thermographic imaging system.

20. A method according to claim 18, characterized in that it comprises the steps of:
automatically feeding a plurality of subsequent multilayer structures on a line into position for inspection;
operating an IR-detection equipment forming a thermographic imaging system for subsequently arriving multilayer structures.

21. A method according to any one of claims 16-20, characterized in that it comprises the steps of:
applying heat to the second layer(s) in a manner allowing fast heating up;
activating the detecting arrangement substantially simultaneously with heating up to allow recording of the transient procedure of heat transport on the first outer surface.

22. A method according to any one of claims 16-21, characterized in that it comprises the steps of:
heating up the second layer from e.g. room temperature to a temperature of approximately 200° C. or below that; preferably to a temperature between 100-150° C.

23. A method at least according to claim 18, characterized in that it comprises the step of:
evaluating the temperature distribution pattern using a processing system to at least determine the size of cavities exceeding a given value.

24. A method according to any one of claims 16-23, characterized in that it comprises the steps of:
providing reference values on temperature distribution patterns corresponding to cavities of a given size;
comparing obtained temperature distribution patterns/ temperature values with said reference values to determine the size(s) of cavities.

25. A method according to any one of claims 16-25, characterized in that it comprises the steps of:
defining a maximum limit for the size of acceptable cavities;
comparing the size(s) of a detected cavity with said maximum value;
automatically activating an alarm if a joint layer contains a cavity/cavities exceeding said maximum value.

26. A method according to claim 25, characterized in that activation of the alarm leads to the step of; for on-line operation,
automatically indicating a multilayer structure having a joint layer with one or more cavities with a size exceeding the maximum value.

27. A method according to any one of claims 16-26, characterized in that the second layer comprises a metal, metal alloy, composite or graphite or similar, that the first layer comprises a ceramic material or a metal alloy or composite such as Kovar, and in that the joint layer comprises a polymer, e.g. a thermoplastic material, a thermosetting material, an adhesive film etc. and in that the second layer has a coefficient of thermal conductivity which is comparatively high whereas the first layer and the joint layer have coefficients of thermal conductivity which are comparatively low such that heat is not too quickly transported.
